(19) United States
(12) Patent Application Publication
(10) Pub. No.: US 2002/0131673 A1
(43) Pub. Date: Sep. 19, 2002

(54) Dynamic optical wavelength balancer

(75) Inventor: Henry Hung, Paradise Valley, AZ (US)

Correspondence Address: DONALD J LENKSZUS PC, PO BOX 3064, CAREFREE, AZ, 85377, US

(73) Assignee: MICRO PHOTONIX INTEGRATION CORPORATION

(21) Appl. No.: 09/810,897

(22) Filed: Mar. 17, 2001

(51) Int. Cl. G02B 6/35; G02B 6/26

(52) U.S. Cl. 385/16; 385/15; 385/24

(57) ABSTRACT

A dynamic optical wavelength balancer is described. The apparatus includes a plurality of wavelength selective reflectors. Each wavelength selective reflector reflects optical signals at a predetermined one optical wavelength selected from a plurality of predetermined optical wavelengths. A bi-directional optical variable coupler array has a first port and a plurality, N, of second ports. Each wavelength selective reflector is coupled to a corresponding one of the second ports. The bi-directional optical variable coupler array is responsive to control signals for establishing different degrees of optical couplings between the first port and selected ones of the plurality of second ports.

### BACKGROUND OF THE INVENTION

This invention relates to optical apparatus, in general, and to an optical wavelength balancer, in particular.

It is desirable to provide optical signals having multiple wavelength components. One problem with such multiple wavelength component signals is that the different components may be at different power levels for a variety of reasons. It is desirable to be able to adjust the distribution of power among the wavelength components.

### SUMMARY OF THE INVENTION

In accordance with the principles of the invention apparatus operable for dynamically adjusting or balancing selected optical wavelengths is provided. The apparatus includes a bi-directional optical variable coupler array coupling a first port to a plurality, N, of second ports. The bi-directional optical variable coupler array is responsive to control signals for establishing selectable bi-directional optical couplings between the first port and the plurality of second ports. The bi-directional optical variable coupler array is operable to selectively adjust the coupling between the first port and each of the second ports. A plurality of wavelength selective reflectors, numbering N, are each coupled to a corresponding one of the second ports, each of the wavelength selective reflectors reflect optical signals at a predetermined one optical wavelength selected from a plurality of predetermined optical wavelengths.

In accordance with an aspect of the invention the bi-directional optical variable coupler array is formed on a substrate. The substrate comprises LiNbO₃.

In accordance with a second embodiment of the invention a second substrate carries the plurality of wavelength selective reflectors. In the second embodiment the second substrate comprises silicon. The second substrate is bonded to the first substrate.

In accordance with another aspect of the invention each wavelength selective reflector comprises a reflective filter. In the illustrative embodiments each reflective filter comprises a Bragg grating that is a fiber Bragg grating.

The bi-directional optical variable coupler array comprises a plurality of stages. Each stage comprises a waveguide structure comprising first, second and third legs formed as a “y”, with said second and third legs forming a “v”, and a first electrode proximate said first leg, a second electrode proximate said second leg and a third common electrode. Selection signals applied to the first, second and third electrodes of said stages selectively adjust coupling between said first port and each of said second ports.

The bi-directional optical variable coupler array is formed on a substrate of electro optic material comprising LiNbO₃.

A dynamic optical wavelength balancer in accordance with the principles of the invention includes a plurality of wavelength selective reflectors. Each wavelength selective reflector reflects optical signals at a predetermined one optical wavelength selected from a plurality of predetermined optical wavelengths. A bi-directional optical variable coupler array has a first port and a plurality, N, of second ports. Each wavelength selective reflector is coupled to a corresponding one of the second ports. The bi-directional optical variable coupler array is responsive to control signals for establishing different degrees of optical couplings between the first port and selected ones of the plurality of second ports.

A micro controller controls the bi-directional optical variable coupler array to establish the different degrees of optical couplings. A bias driver, responsive to the micro controller provides the control signals.

A detector coupled to the output provides signals representative of the wavelength components. The detector is coupled to the micro controller.

### BRIEF DESCRIPTION OF THE DRAWING

The invention will be better understood from a reading of the following detailed description taken in conjunction with the several drawing figures in which like reference designations are used to identify like elements in the figures, and in which:

FIG. 1 shows a structure in accordance with the principles of the invention;

FIG. 2 is a second embodiment in accordance with the principles of the invention;

FIG. 3 illustrates a specific structure in accordance with the embodiment of FIG. 2;

FIG. 4 illustrates a portion of the structure of FIG. 3 in greater detail;

FIG. 5 is a top view of a fiber Bragg grating array in accordance with one aspect of the present invention;

FIG. 6 is an end view of the array of FIG. 5; and

FIG. 7 illustrates an alternate embodiment of the structure of FIG. 3.

### DETAILED DESCRIPTION

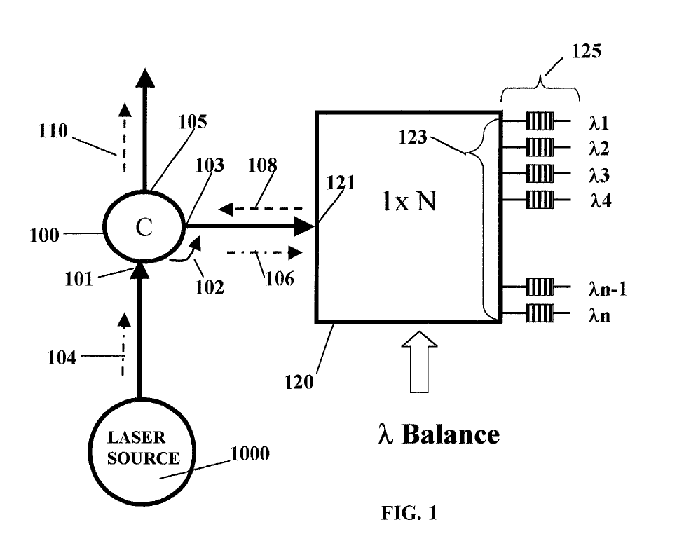

FIG. 1 illustrates the general configuration of apparatus in accordance with the principles of the invention. Optical signals from a source 1000 are applied to an input port 101 of a three port optical circulator 100. Optical circulator 100 has a second port 103 coupled to optical switch 110. A third port 105 serves as an output port. Circulator 100 may be any one of a number of known circulators. An isolator may be inserted into the optical path coupling the source of optical signals to port 101 to make port 101 unidirectional. Similarly, an optical isolator may be inserted into the optical path coupled to port 105 so that optical signals flow unidirectionally out from port 105. Port 103 is a bi-directional port that receives optical signals from port 101 and couples optical signals received at port 103 to port 105. The polarity of circulator 100 is indicated by directional arrow 102. Arrows 104, 106 show the flow of input optical signals to bi-directional optical waveguide tree 120. The flow of wavelength selected optical output signals from optical tree 120 to port 103 and out from port 105 is shown by arrows 108, 110. Optical tree 120 is operable to couple port 121 to any of a plurality, n, of ports 123. Each port of the plurality of ports 123 has coupled thereto a corresponding one of a plurality of reflective wavelength filters 125. Each reflective wavelength filter 125 is a narrow filter and in the illustrative embodiment may be either a fiber Bragg grating or a dielectric interference filter. Both fiber Bragg gratings and dielectric interference filters are known in the art. Each wavelength filter 125 is selected to reflect optical signals that are only at a specific centerline wavelength designated as λ1-λn. The number of filters 125 utilized is dependant upon the specific application and the incremental wavelength difference between adjacent selected wavelengths. Stated another way, the number of filters 125 is determined by the number of wavelength components and the incremental wavelength, or wavelength granularity between selections. Bi-directional optical variable coupler array 120 receives wavelength selection signals and couples port 121 to selected ones of ports 123 based upon the selection signals. The selection of ones of ports 123 is made based upon the desired wavelength of optical signals desired. Each of the narrow filters 125 reflects optical signals only at the particular center wavelength of the filter and passes or in effect absorbs all other optical signals. Input optical signals received at circulator 100 port 101 are coupled to port 103 and coupled to port 121 of tree 120. Tree 102 couples the optical signals to selected ones of filters 125. The selected ones of filters 125 are determined by wavelength select signals received by tree 120.

Each selected filter 125 reflects only optical signals at its predetermined wavelength back to port 121 and thence to circulator 100 port 103. The selected wavelength optical signals are coupled out of circulator 100 at port 105. In a first embodiment of the invention, bi-directional optical variable coupler array 120 couples one port to N ports. In a second embodiment of the invention, bi-directional optical variable coupler array 120 is formed on a LiNbO₃ substrate or a substrate of other electro-optic material. This embodiment has the advantages of a high wavelength channel count, fast switch speed and small size.

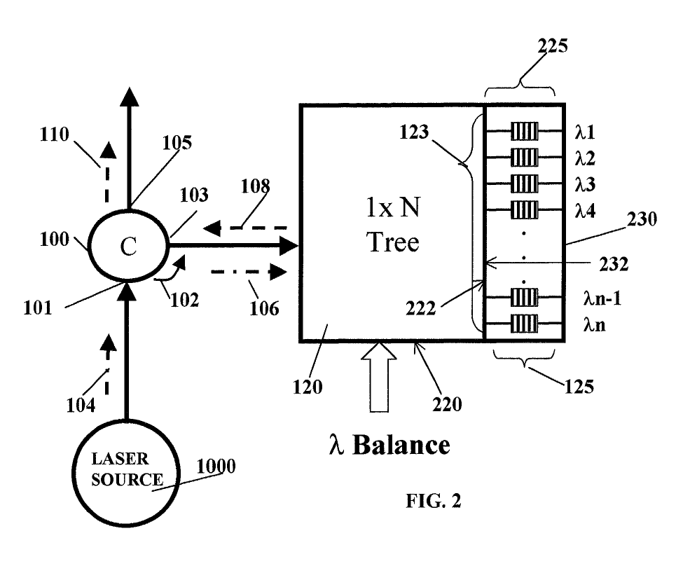

In a second embodiment in accordance with the invention shown in FIG. 2, 1×N bi-directional optical variable coupler array 120 is again formed on a LiNbO₃ substrate 220 or a substrate of other electro-optic material. Particular details of the 1×N bi-directional optical variable coupler array are not shown on the structure of FIG. 2, however, in this particularly advantageous embodiment of the invention, the plurality of filters 125 is arranged as a fiber Bragg grating array 225 of filters. A plurality, n, of fiber Bragg gratings 225 are provided on a separate substrate 230 that is affixed to substrate 220. More specifically, a plurality, n, of fiber Bragg gratings 225 are bonded to grooves or channels formed on the surface of a substrate 230. In the specific embodiment shown, substrate 230 is selected to be a silicon substrate. The end surface 232 of substrate 230 that is adjacent to substrate 220 is polished. End surface 232 is bonded to surface 222 of substrate 220. Bonding of substrate 220 to substrate 230 may be by any one of several known arrangements for bonding substrates together.

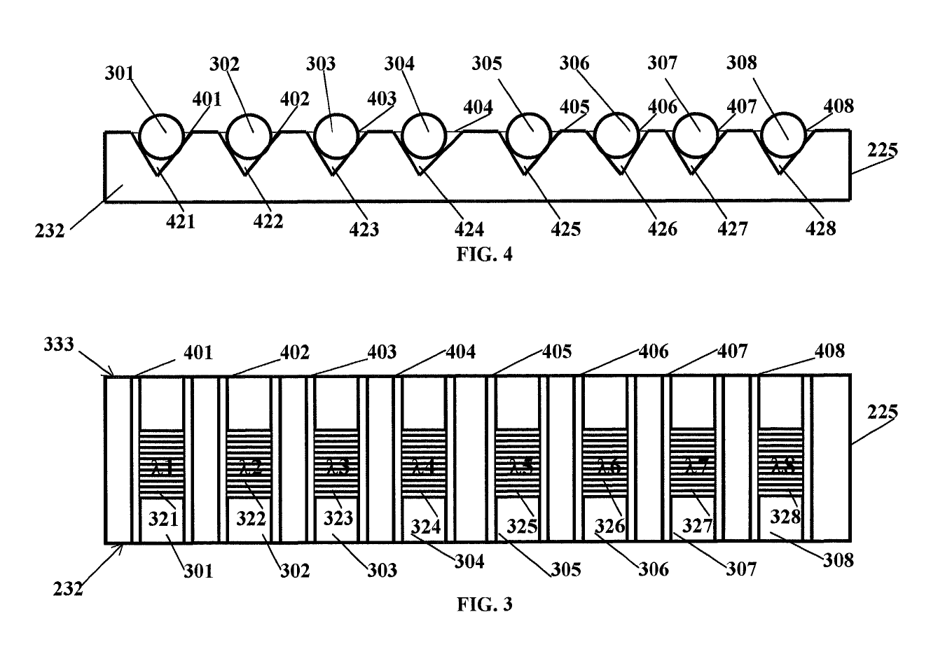

FIGS. 3 and 4 show a fiber Bragg grating array 225 with 8 fiber Bragg grating filters λ1-λ8. Each of the fiber Bragg grating filters λ1-λ8 is a separate fiber segment 301-308 having a Bragg grating 321-328 formed thereon. Each fiber segment is a photosensitive fiber onto which a Bragg grating is formed by using ultraviolet light in conjunction with a different period phase mask for each different filter center wavelength. The forming of Bragg gratings on fibers utilizing such a technique is known in the art. Silicon substrate 230 has a plurality of grooves 401-408 formed on a top surface 412. Each of the grooves 401-408 is shown as a “v” groove, but may be of different cross sectional shape, and rather than being shaped as a “groove” may be a channel. By use of the term “channel”, it will be understood that various cross-sectional grooves is included. In the embodiment shown, the grooves or channels may be formed by use of a saw, or by etching or any other process that will permit controlled depth formation of channels. For example, the v-grooves may be formed by providing an oxide masking layer on the silicon substrate, utilizing a photolithography process to define each of the grooves, and applying an etchant to form the grooves 401-408. After the grooves 401-408 are formed, the fiber segments 301-308 are placed in the grooves 401-408 with fixed spacing and are bonded in position with epoxy. The end surfaces 232, 333 of substrate 230 as well as the corresponding end faces of fiber segments 301-308 are coplanar and polished to optical quality. The corresponding end surface 222 of substrate 220 is likewise polished to optical quality. The fiber Bragg grating array 225 is aligned with the 1×N bi-directional optical variable coupler array 120 substrate 220 and bonded thereto. The bonding may with epoxy or any other method of bonding that provides good optical coupling.

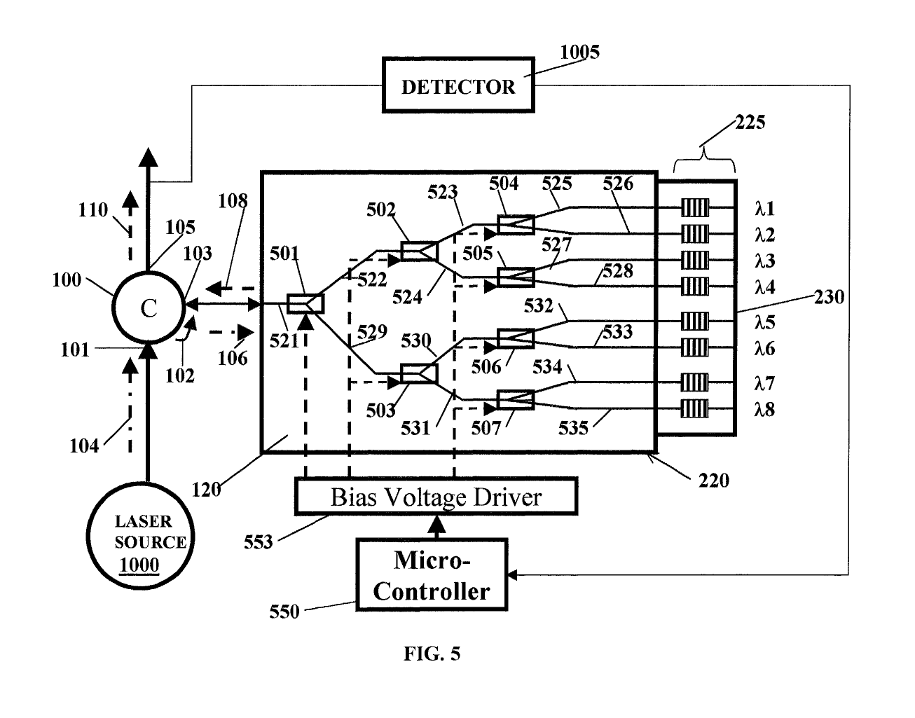

Turning now to FIG. 5, the apparatus of FIG. 2 is shown with 1×N bi-directional optical variable coupler array 120 shown in greater functional detail. 1×N bi-directional optical variable coupler array 120 is formed from an array of 1×2 optical switches 501-507 and waveguides 521-535. Switches 501-507 are selectively operated by a microprocessor or micro-controller 550 that responds to wavelength signals indicating a desired optical wavelength and determines which optical switches 501-507 to operate to couple optical signals to corresponding fiber Bragg gratings 125 of array 225. In operation, a wavelength selective detector 1005 is utilized to monitor output optical signals from circulator 100 and to provide signals representative of the power of each wavelength component at the output port 105 of circulator 100. Micro controller 550 utilizes the signals receive from detector 1005 to control bias voltage driver 553 to adjust the level of optical signals at desired wavelength components reflected to circulator port 103. Micro controller 550 determines the levels of the various wavelength components and may vary the levels. The variation in levels may be in accordance with predetermined levels that are provided to micro controller 550, or in accordance with algorithms provided to micro controller 550. The level of each wavelength component may be varied from zero to a maximum level and is determined by the operation of switches 501-507. Operation of switches 501-507 is determined by the selective application of bias voltages to switches 501-507 by bias voltage driver 553.

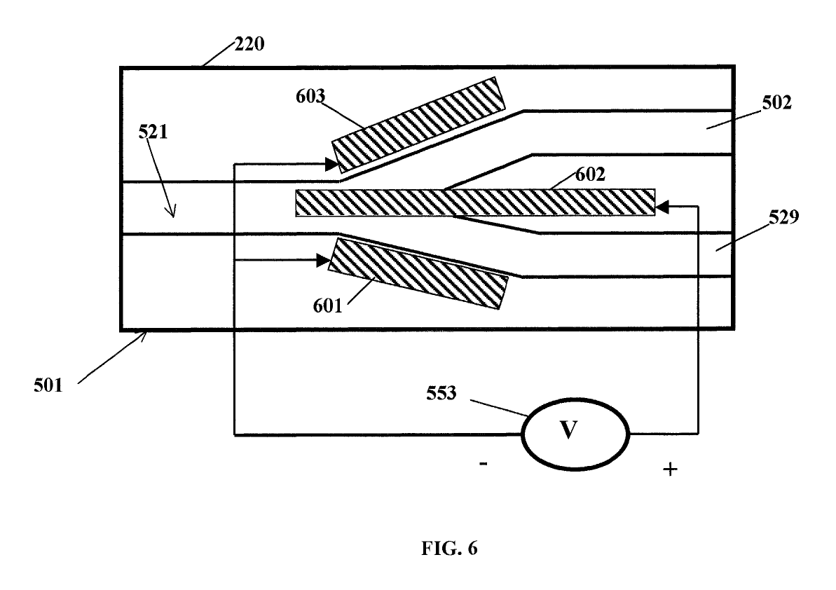

FIG. 6 illustrates a 1×2 switch 501 that is appropriate for use in the 1×N bi-directional optical variable coupler array 120 of the invention. Switch 501 is a bi-directional, polarization independent 1×2 switch design. It includes a waveguide that forms a “y” having first, second and third waveguide legs 521, 522, 529. The waveguides 521, 522, 529 are formed on a substrate utilizing known fabrication methods for forming optical waveguides on electro optic substrates such as LiNbO₃. Switch 501 further includes three electrodes 601, 602, 603 that are used to determine the optical path through switch 501. The application of bias voltage V to electrodes 601, 602, 603 determines the degree of coupling between waveguide portion 521 and waveguide portions 522 and 529. The high voltage switch 501 can couple both TE and TM mode signals. Switch 501 has an on-off ratio of greater than 20 dB. In a reflective design, a double pass produces 40 dB of isolation. With this building block switch structure other sized switches may be provided. In operation, each switch 501 acts as a variable bi-directional coupler that is operated by appropriate selection of bias voltage to determine the amount of coupling between one port and two other ports.

Although switch 501 is shown in detail in FIG. 6, each of the switches 501-507 is of the same construction and all are fabricated on a single substrate 220 in the illustrative embodiment. The waveguides 521-535 are formed utilizing any of the known techniques for formation of waveguides in electro-optic substrates.

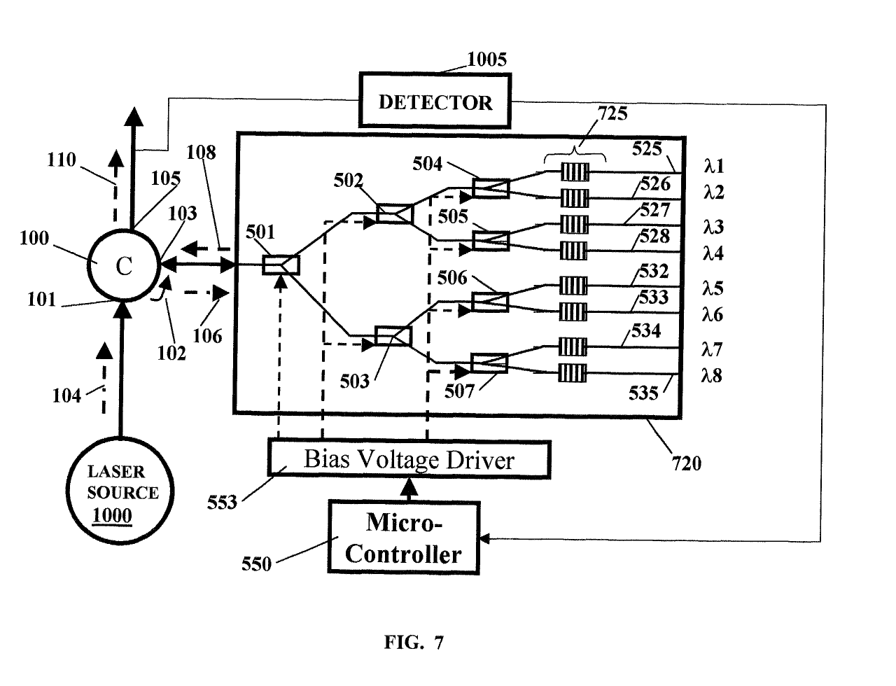

FIG. 7 illustrates another embodiment of the invention in which the reflective filters 525-535 are formed on the same substrate 720 as the 1×N Switch. The substrate is LiNbO₃ or another electro optic material. Each filter 725 is formed on a waveguide 525-528, 532-535 formed on substrate 720. Each waveguide has a photosensitive region onto which a Bragg grating is formed. Operation of the structure of FIG. 7 is the same as that of FIG. 5.

It should be apparent to those skilled in the art that although certain structures shown in the drawing figures illustrate only a 1×8 bi-directional optical variable coupler array and 8 wavelengths, the number of wavelengths and the size of the 1×N bi-directional optical variable coupler array is a matter of design selection to provide the desired number of selectable wavelengths. For example, 1×16 and 1×32 bi-directional optical variable coupler arrays can be built. If it is desired to accommodate a larger number of wavelengths, cascading several stages can accommodate more wavelengths. For example, to accommodate 128 wavelengths, a 1×4 bi-directional optical variable coupler array can be cascaded with four 1×32 bi-directional optical variable coupler arrays.

Various other changes and modifications may be made to the illustrative embodiments of the invention without departing from the spirit or scope of the invention. It is intended that the invention not be limited to the embodiments shown, but that the invention be limited in scope only by the claims appended hereto.

What is claimed is:

1. Apparatus operable for dynamically adjusting selected wavelength components, comprising:
a bi-directional optical variable coupler array coupling a first port to a plurality, N, of second ports, said optical switch being responsive to control signals for establishing selectable bi-directional optical couplings between said first port and said plurality of second ports, said bi-directional optical variable coupler array being operable to selectively adjust the coupling between said first port and each of said second ports; and
a plurality of wavelength selective reflectors, said wavelength selective reflectors numbering N, each of said wavelength selective reflectors being coupled to a corresponding one of said second ports, each of said wavelength selective reflectors reflect optical signals at a predetermined one optical wavelength selected from a plurality of predetermined optical wavelengths.

2. Apparatus operable for dynamically adjusting selected wavelength components in accordance with claim 1, comprising:
a first substrate having said bi-directional optical variable coupler array formed thereon.

3. Apparatus operable for dynamically adjusting selected wavelength components in accordance with claim 2, wherein:
said first substrate comprises an electro-optic material.

4. Apparatus operable for dynamically adjusting selected wavelength components in accordance with claim 3, wherein
said substrate comprises LiNbO₃.

5. Apparatus operable for dynamically adjusting selected wavelength components in accordance with claim 2, comprising:
a second substrate carrying said plurality of wavelength selective reflectors.

6. Apparatus operable for dynamically adjusting selected wavelength components in accordance with claim 5, wherein:
said second substrate comprises silicon.

7 Apparatus operable for dynamically adjusting selected wavelength components in accordance with claim 6, wherein:
said second substrate is bonded to said first substrate.

8. Apparatus operable for dynamically adjusting selected wavelength components in accordance with claim 1, wherein:
each of said wavelength selective reflectors comprises a reflective filter.

9. Apparatus operable for dynamically adjusting selected wavelength components in accordance with claim 8, wherein:
each of said reflective filters comprises a Bragg grating.

10. Apparatus operable for dynamically adjusting selected wavelength components in accordance with claim 8, wherein:
each of said reflective filters comprises a fiber Bragg grating.

11. Apparatus operable for dynamically adjusting selected wavelength components, in accordance with claim 1, wherein:
said bi-directional optical variable coupler array comprises a plurality of stages, each of said stages comprises a waveguide structure comprising first, second and third legs formed as a “y”, with said second and third legs forming a “v”, and a first electrode proximate said first leg, a second electrode proximate said second leg and a third common electrode.

12. Apparatus operable for dynamically adjusting selected wavelength components, in accordance with claim 11, wherein:
selection signals applied to said first, second and third electrodes of said stages selectively adjusts coupling between said first port and said second ports.

13. Apparatus operable for dynamically adjusting selected wavelength components, in accordance with claim 1, comprising:
a substrate of electro optic material having said tree formed thereon.

14. Apparatus operable for dynamically adjusting selected wavelength components, in accordance with claim 13, wherein:
said substrate comprises LiNbO₃.

15. Apparatus operable for dynamically adjusting selected wavelength components, in accordance with claim 1, wherein:
said bi-directional optical variable coupler array is polarization independent.

16. Apparatus operable for dynamically adjusting selected wavelength components, in accordance with claim 1, comprising:
a micro controller coupled to said bi-directional optical variable coupler array for controlling operation thereof.

17. Apparatus operable for dynamically adjusting selected wavelength components, comprising:
a plurality of wavelength selective reflectors, said wavelength selective reflectors numbering N, each of said wavelength selective reflectors reflecting optical signals at a predetermined one optical wavelength selected from a plurality of predetermined optical wavelengths; and
a bi-directional optical variable coupler array having a first port and a plurality, N, of second ports, each of said wavelength selective reflectors being coupled to a corresponding one of said optical tree second ports, said bi-directional optical variable coupler array being responsive to control signals for establishing different degrees of optical couplings between said first port and selected ones of said plurality of second ports.

18. Apparatus operable for dynamically adjusting selected wavelength components in accordance with claim 17, wherein:
each of said wavelength selective reflectors comprises a reflective filter.

19. Apparatus operable for dynamically adjusting selected wavelength components in accordance with claim 18, wherein:
each of said reflective filters comprises a Bragg grating.

20. Apparatus operable for dynamically adjusting selected wavelength components in accordance with claim 18, wherein:
each of said reflective filters comprises a fiber Bragg grating.

21. Apparatus for dynamically adjusting selected wavelength components, in accordance with claim 17, comprising:
an optical variable coupler array having a first port and a plurality, N, of second ports, each of said wavelength selective reflectors being coupled to a corresponding one of said optical variable coupler array second ports, said optical variable coupler array being responsive to control signals for establishing different degrees of optical couplings between said first port and selected ones of said plurality of second ports;
a bi-directional optical variable coupler array having a first port and a plurality, N, of second ports, each of said wavelength selective reflectors being coupled to a corresponding one of said bi-directional optical variable coupler array second ports, said bi-directional optical variable coupler array being responsive to control signals for establishing different degrees of optical couplings between said first port and selected ones of said plurality of second ports; and
a micro controller for controlling said bi-directional optical variable coupler array to establish said different degrees of optical couplings.

22. Apparatus operable for dynamically adjusting selected wavelength components in accordance with claim 21, comprising:
a bias driver, responsive to said micro controller for providing said control signals.

23. Apparatus operable for dynamically adjusting selected wavelength components in accordance with claim 22, comprising:
a detector couple to the output of said apparatus for providing signals representative of said wavelength components, said detector being coupled to said micro controller.

24. Apparatus operable for dynamically adjusting selected wavelength components in accordance with claim 21, comprising:
a detector couple to the output of said apparatus for providing signals representative of said wavelength components, said detector being coupled to said micro controller.
